(19) United States
(12) Patent Application Publication
(10) Pub. No.: US 2026/0368344 A1
(43) Pub. Date: Nov. 19, 2026

(54) SECURE DOCUMENT CONTENT VIEWING

(71) Applicant: Oracle International Corporation, Redwood Shores, CA (US)

(72) Inventors: Sandeep Singhania, Pleasanton, CA (US); Balamurugan Manoharan, Pleasanton, CA (US); Raji Gopalakrishnan Nair, Pleasanton, CA (US); Aswin Lakshmi Narashiman, Austin, TX (US)

(73) Assignee: Oracle International Corporation, Redwood Shores, CA (US)

(21) Appl. No.: 19/208,789

(22) Filed: May 15, 2025

(51) Int. Cl. G06F 21/62

(52) U.S. Cl. CPC G06F 21/6218

(57) ABSTRACT

A system, article, and computer-implemented method are disclosed for providing secure access to view documents. A first request is accessed for a link to a document and a link owner user identifier is determined. The request includes a document identifier. Based on the document and user identifiers, the system generates an encrypted link to the document which is returned to the document viewing application. The system accesses a second request to view the document using the encrypted link and determines that the second request is submitted in association with a particular user identifier. The system decrypts the link to obtain the link owner user identifier, which is compared against the particular user identifier to ensure they are the same. The system transforms data of the document into a PDF format and returns the data of the document in the PDF format for display by the document viewing application.

### BACKGROUND

Within a database-managed document access system, controlling access by various users to documents stored on the database is important for security management of the database. Use of security credentials and access controls adds security to a database by preventing requests to access documents where the requesting user does not have permission to access the document. But once a user with permission to access a document has submitted a valid request, there is an additional security risk of users without permission to access the document gaining improper access via the fulfilment of the valid user's request.

Users pose significant security risks as different users treat data differently, with different levels of precaution. While one user may email critical information or a link to critical information, another user may store such information only in a secure database or on a piece of paper to be shredded. These different levels of information protection employed by different users may lead to unexpected leaks of information from an otherwise secure system. Many secure systems do little to protect users from their own information handling mistakes.

### BRIEF SUMMARY

In some embodiments, a system, article, and computer-implemented method are disclosed for providing secure access to view documents. A first request is accessed for a link to a document and a link owner user identifier is determined. The request includes a document identifier. Based on the document and user identifiers, the system generates an encrypted link to the document which is returned to the document viewing application. The system accesses a second request to view the document using the encrypted link and determines that the second request is submitted in association with a particular user identifier. The system decrypts the link to obtain the link owner user identifier, which is compared against the particular user identifier to ensure they are the same. The system transforms data of the document into a PDF format and returns the data of the document in the PDF format for display by the document viewing application.

In a particular embodiment, a computer-implemented method includes accessing a first request for a link to one or more documents. The first request includes one or more document identifiers of the one or more documents, and the first request is associated with an application session for content provision to a user of a document viewing application. The computer-implemented method also includes determining a link owner user identifier for the user based at least in part on the application session and validating that the user has access to a document of the one or more documents. The computer-implemented method also includes validating that the user has access to the document and based at least in part on a document identifier of the one or more document identifiers and the link owner user identifier, generating an encrypted link to the document. Iin response to the first request, the encrypted link is returned to the document viewing application for use in content provision to the user. A second request is accessed to view the document using the encrypted link. The computer-implemented method also includes determining that the second request is submitted on behalf of a particular user identified by a particular user identifier, decrypting the encrypted link to obtain the link owner user identifier, and comparing the link owner user identifier to the particular user identifier. In response to determining that the link owner user identifier matches the particular user identifier, data of the document is transformed into a PDF format from a different original format and, in response to the second request, the data of the document is returned in the PDF format for display by the document viewing application.

In a further embodiment, the determining that the second request is submitted on behalf of the particular user identified by the particular user identifier includes accessing information stored for a particular application session from which the second request originated. The accessing the particular user identifier is performed via a secure protocol.

In the same or a different further embodiment, the second request further includes a request to view a second document using a second encrypted link. The computer-implemented method also includes decrypting the second encrypted link to obtain the link owner user identifier, in response to determining that the link owner user identifier matches the particular user identifier, transforming data of the second document into a PDF format from a different original format, and returning, in response to the second request, the data of the second document in the PDF format for display by the document viewing application.

In another embodiment that extends the particular embodiment or any further embodiment, the first request from the user is one of a plurality of requests for links to documents. The computer-implemented method also includes accessing a third request from the user for a second link to a second document. The third request includes a second document identifier. After validating that the user has access to the second document and based at least in part on the second document identifier and the link owner user identifier, a second encrypted link to the second document is generated.

In another embodiment that extends the particular embodiment or any further embodiment, the first request from the user is one of a plurality of requests for links to documents. The computer-implemented method also includes accessing a third request for a second link to a second document, including a second document identifier, and after validating that a corresponding user has access to the second document and based at least in part on the second document identifier and a corresponding link owner user identifier, generating a second encrypted link to the second document. The computer-implemented method also includes accessing a third request to view the second document using the second encrypted link, determining that the third request is submitted on behalf of a second particular user identified by a second particular user identifier, decrypting the second encrypted link to obtain the corresponding link owner user identifier and comparing the corresponding link owner user identifier to the second particular user identifier. In response to determining that the corresponding link owner user identifier matches the particular user identifier, the computer-implemented method includes transforming data of the second document into a PDF format from a different original format and returning, in response to the third request, the data of the second document in the PDF format for display by the document viewing application. The transforming the data of the second document and the transforming the data of the document are performed in parallel.

In another embodiment that extends the particular embodiment or any further embodiment, the user and the corresponding user are a same user of the document viewing application.

In another embodiment that extends the particular embodiment or any further embodiment, the returning, in response to the second request, the data of the document in the PDF format for display by the document viewing application includes transmitting a byte stream of the data of the document in the PDF format.

In another embodiment that extends the particular embodiment or any further embodiment, the document is displayed with an option to trigger a particular action. The computer-implemented method also includes determining a type of action to support based at least in part on metadata about the document, detecting a user-initiated trigger of the particular action on the document, and in response to the user-initiated trigger, causing performance of the particular action on the document. The particular action is of the determined type of action and different documents are displayed with options to trigger different actions.

In another embodiment that extends the particular embodiment or any further embodiment, the second request includes a request to view one or more items of structured information associated with the document. The computer-implemented method also includes determining a layout for displaying the one or more items of structured information within a PDF format. Transforming the data of the document into the PDF format includes adding the one or more items of structured information in the determined layout to the data of the document in the PDF format.

In another embodiment that extends the particular embodiment or any further embodiment, the transforming the data of the document into the PDF format is performed in a plurality of sub-steps with each sub-step including transforming a portion of the document into the PDF format. The returning, in response to the second request, the data of the document in the PDF format includes returning a first portion of data of the document in the PDF format. The computer-implemented method also includes accessing a third request to access a second portion of the document, transforming data of a second portion of the document into the PDF format, and returning, in response to the third request, the data of the second portion of the document in the PDF format for display by the document viewing application.

In another embodiment that extends the particular embodiment or any further embodiment, the accessing a second request to view the document using the encrypted link includes accessing an appended limitation to the view of the document. The transforming the data of the document into the PDF format includes transforming data corresponding to the limited view of the document without transforming data that does not correspond to the limited view of the document.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory and/or transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items or separate process instances of a set of process instances. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process for providing secure access to view documents retrieved from a database.

FIG. 2 illustrates a system diagram showing an example cloud infrastructure for providing secure access to view documents.

FIG. 3 illustrates a diagram of an example user interface for previewing documents retrieved from a database.

FIG. 4 depicts a simplified diagram of a distributed system for implementing certain aspects.

FIG. 5 is a simplified block diagram of one or more components of a system environment by which services provided by one or more components of an embodiment system may be offered as cloud services, in accordance with certain aspects.

FIG. 6 illustrates an example computer system that may be used to implement certain aspects.

### DETAILED DESCRIPTION

In some embodiments, a system, article, and computer-implemented method are disclosed for providing secure access to view documents. In serving document data to satisfy a request to view a document, a unique content identifier and a user identifier are used to generate an encrypted link that is provided only to link owner (e.g., the requesting user) to allow only the link owner to view the requested document. If such a link ends up being stored in an unsafe location and is discovered by another user, the other user would not be able to use the link unless the other user is authenticated as the link owner. In various embodiments, a content management system provides access to securely view documents retrieved from a database and is implemented using non-transitory and/or transitory computer-readable storage media to store instructions which, when executed by one or more processors of a computer system, cause display of the user interface and processing of the received input to provide access to securely view documents retrieved from a database. The content management system may be implemented on a local or cloud-based computer system that includes processors and a display for showing the user interface to a user for providing access to securely view documents retrieved from a database. The computer system may communicate with client computer systems for providing access to securely view documents retrieved from a database.

A description of a content management system is provided in the following sections:
REGISTERING CONTENT WITHIN A DATABASE
USER REQUEST TO VIEW DOCUMENTS
GENERATING AN ENCRYPTED LINK FOR REQUEST
ACCESSING THE ENCRYPTED LINK TO RETRIEVE DATA
SERVING DOCUMENT CONTENTS
ACTIONS IN VIEWING DOCUMENTS
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Registering Content Within a Database

Content for documents on the content management system is uploaded by content management user(s) for later access by content consuming users. The content management user(s) upload the content of one or more documents to an interface for the content management system such as a web interface or a content management window of a content access application. The contents of one or more documents may be of any document type that is human-viewable. The content management system receives the data of the content, stores the data within a database, and generates a content ID for the document to uniquely identify the uploaded content. Content data is stored in association with the content ID such as in a table in a key-value pairing with content ID. In some embodiments, version information for a document may be tracked and a version number may be kept in addition to a content ID. In other embodiments, different versions of a document may be treated as separate documents receiving separate content IDs.

The content management system returns the content ID to the interface or content access application. The interface or content access application stores the content ID to provide options for content retrieval from the document and/or for future requests to access the document such that the content may be identified between the content management system and the interface or content access application using the content ID. If the content is uploaded to the database by a separate application from a content access application, the content management system may also send an update to the content access application of the newly generated content ID and any related information about the document the content ID corresponds to. In this way, the information about the document may be displayed to future users of the content access application for selecting the document as a document to view.

Uploading content to the database may be restricted to certain users. The restriction of access to upload content may be controlled by access controls to the user interface, a document upload window of the user interface, or by checking a set of user credentials by the content management system when receiving an upload of content. Uploaded content may be viewable by other users or not viewable by other users depending on who uploaded the content, a type of content uploaded, entities associated with the content (and whether those entities are also associated with other users), roles to which the content or content type is associated, or based on any other security profile applied to the uploaded content to determine which users may access the uploaded content. For example, content may be uploaded in association with an entity, and the content may be viewable by any user or group of users also associated with the entity. A user authorization check may be performed before providing access to the content.

### User Request to View Documents

A content consuming user submits a request for a link to access a document via a content access application with stored knowledge of one or more documents accessible to the content consuming user and stored in a database. The request may be submitted by selecting the document within a user interface from a list of known documents stored in a database within a content management system and accessible by the content consuming user. The documents accessible by the content consuming user may be determined to be accessible by the content consuming user by application of a set of user credentials that control access to documents stored on the database. The content consuming user may access the user interface of the content access application by registering the set of user credentials which may be stored in association with a session for content provision of the application within which the content consuming user may access the user interface of the content access application.

Within the session of the content access application, the user interface may display information about a set of documents accessible to the content consuming user. The set of documents may be determined by filtering or selecting documents stored on the database by applying the set of user credentials or other security policies such as policies defined in a security profile. After the user interface loads the information about the set of documents, the set of documents may be further filtered by settings defined by the content consuming user. For example, the content consuming user may, after the user interface displays the set of documents, select a filtering setting such as a value for a field of metadata associated with the set of documents. Alternatively, the content consuming user may, before the user interface displays the set of documents, define a setting for preferred document types which may be used to filter the set of documents displayed in the user interface.

In an alternative embodiment, the user interface may not display the set of documents, but may permit navigation of the set of documents by the content consuming user via an interfaces such as a search function. The content consuming user may enter search criteria to the search function to navigate the set of documents loaded by the user interface and select one or more documents to display. The user interface may load the documents in response to the content consuming user entering search criteria, in which case the search criteria may be used as a filtering setting to filter the set of documents loaded prior to displaying the set of documents as results to the search criteria.

From the set of documents displayed in the user interface, the content consuming user may select one or more documents to view in a document previewer. The one or more documents selected to view may be selected by user interaction with a display of information about the selected documents within the user interface such as clicking a document name or interacting with a checkbox associated with data about a document. Alternatively, the one or more documents selected to view may be selected for viewing by detecting an action by a content consuming user to attempt to perform an action with the selected documents wherein the action requires preview of the documents before the action may be performed.

In response to the content consuming user selecting one or more documents for viewing, the user interface of the content access application may initialize a document viewer. The document viewer may be a region of the user interface or may be a new window generated for viewing documents selected by the content consuming user. The document viewer may be initialized by loading initial settings for displaying documents and/or by generating the document viewer window if the document viewer is a separate window of the user interface. The content access application may be a lightweight application such as a webpage within a web browser. As the document request application may be within a web browser, the web browser's in-built support for viewing PDF documents may be leveraged to initialize the document viewer with the expectation that the documents will be displayed in a PDF format. The document viewer may initialize based on the document type or characteristics of the documents to be displayed. For example, the document viewer may initialize in a portrait mode, defining a height and width of the document viewer window based on characteristics of the documents to be displayed indicating the documents are in a portrait orientation.

The document viewer may also be initialized with one or more controls for use by the content consuming user in interacting with the documents displayed in the document viewer. For example, the document viewer may contain navigation controls for navigating forwards or backwards within a list of documents requested to be viewed in the document viewer. The one or more controls may also be controls specific to the document or type of document to be viewed, which may permit additional actions to be performed with respect to the documents viewed. For example, a document may contain a table, in which case the document viewer may be initialized with an edit control or one or more table navigation tools used for interacting with the data of the table document.

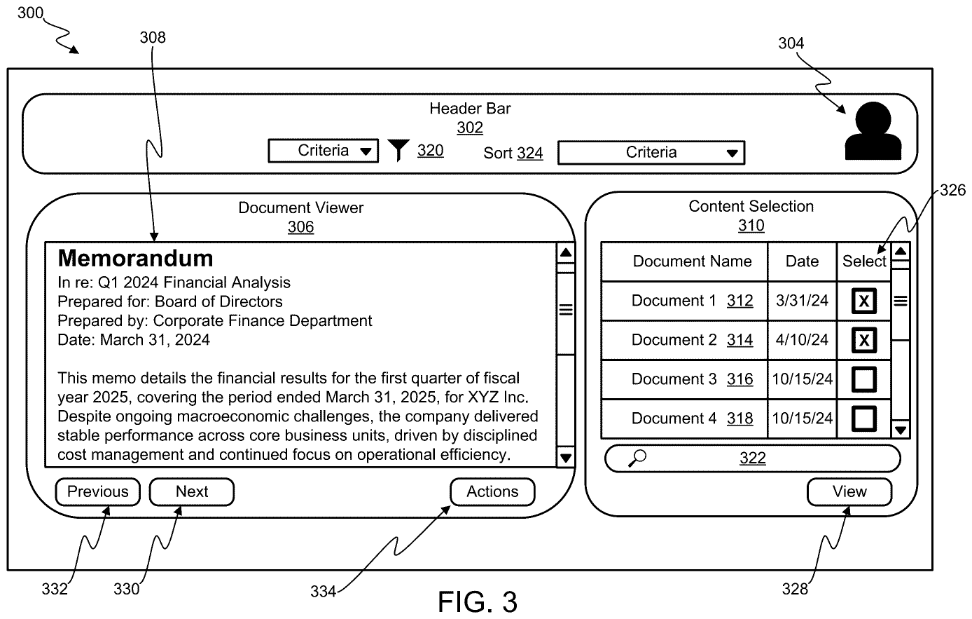

FIG. 3 depicts an example user interface 300 for a content viewing application. The user interface 300 contains a navigation region 302 containing one or more navigation or control tools for the contents of the user interface 300. The user interface 300 may recognize a user 304 via a set of user credentials. The set of user credentials may control access to documents displayed within the user interface 300. The user interface contains a document viewer region 306 that may display a current document 308. The current document may be selected from a content selection region 310. The content selection region 310 displays one or more document choices 312-318. The one or more document choices 312-318 may be filtered by applying access controls with the set of user credentials of the user 304 or by applying a filter criteria 320. The one or more document choices 312-318 may be sorted by a sort criteria 324, or searched to find a particular document via a search function 322. One or more documents may be selected via a selection option 326 and confirmed for viewing within the document viewer region 306 by selecting the viewing confirmation option 328. After selection, a plurality of documents displayed in the document viewer region 306 may be navigated by a set of navigation commands 330-332. A current document 308 may also correspond to one or more commands relevant for the document which may be performed by a command selection 334.

In response to the content consuming user selecting the one or more documents for viewing, the content access application may generate a request to load content for the one or more documents selected for viewing. The one or more documents selected for viewing may be stored in a database, in that the content of the documents are stored within the database along with information about the documents, such as metadata, which may be shared with the content access application for purposes of searching the available documents for viewing. The content for the one or more documents selected for viewing is identified between the content access application and the database by a content ID associated with each document selected for viewing. The content ID may be a unique document name or identification number for the content which is not duplicated between documents of the database. The content ID for each document is shared between the database and the content access application such that communications between the content access application and the database may identify, with a unique identifier, documents that may share similar data such as similar metadata or document names. The content access application compiles each of the content IDs for each of the selected one or more documents for viewing and submits one or more requests, including the one or more content IDs, to the database for accessing the content of the selected one or more documents for viewing.

The one or more requests submitted to the database may also contain information about the content consuming user such as the set of user credentials. The database may use the information about the content consuming user to determine if the content consuming user has access to the one or more documents selected for viewing. For example, the database may apply the set of user credentials sent as part of the one or more requests to satisfy one or more access controls for the one or more documents selected for viewing.

### Generating an Encrypted Link for Request

After receiving a request for content including a content ID, an encryption service is called to generate an encrypted link used for accessing the content for the one or more documents selected for viewing by the content consuming user. The encrypted link is generated based on the identifier of the document(s) to be accessed and a link owner user identifier such as a user ID or set of user credentials. For example, the link owner user identifier may be input into a hash algorithm or other encryption algorithm or sequence of encryption algorithms to generate an encrypted value, which may be used in a link (also referred to as an encrypted link). Using the user ID to generate the encrypted value may be used to restrict access to the request to only one individual user. A set of user credentials may be used to identify one or more users which may be granted access to the request such as a user role or a list of user IDs. The encrypted link may also be generated in part based on the version information of the document(s) in the case that a separate content ID is not used for different versions of a same document. The encrypted link may also be generated in part based on a time code for the access request. The encrypted link is a unique encrypted token for the one or more requests and is returned to the content access application session submitting the one or more requests.

The encrypted link may be generated by inputting the input values of the document identifier, link owner user identifier, set of user credentials, or any other relevant information as an input value to an encryption algorithm. The encryption algorithm is deterministic, in that it always give the same output for the same input and is reversable or decryptable so long as any key used for the decryption is available to use to decrypt the output. The encryption algorithm also generates a different result for each input value. A reversable encryption algorithm takes as input a seed value and outputs an encrypted value that encodes the seed values as information within the encrypted value in a way that the seed value may be obtained by decrypting the encrypted value. Possible reversable encryption algorithms include Advanced Encryption Standard, ChaCha20, Twofish, 3DES, Blowfish, RC4, CAST5, IDEA, Serpent, RSA, Elliptic Curve Cryptography, ElGamal, Digital Signature Algorithm, Paillier, or NTRU.

A generated encrypted link for accessing content of a particular document changes with each access so that every access by different content consuming users utilizes a different encrypted link. The encrypted link ensures that only the content consuming user who submitted the request and has the right to access the content will receive the content for the one or more documents selected for viewing. The encrypted link also applies the database level access control for the content to the content access application displaying the content of the one or more documents selected for viewing.

The encryption service transmits the encrypted link to the content access application. The encryption service may transmit the encrypted link to a same session of the content access application from which the request to the encryption service was received. In this way, the encrypted link may be ensured to be provided only to the requesting user. The content access application receives the encrypted link and stores the encrypted link for use to access the data of the one or more documents selected for viewing.

### Accessing the Encrypted Link to Retrieve Data

The content access application accesses the encrypted link to retrieve data for the one or more documents selected for viewing to be displayed within the document viewer of the content access application. The encrypted link may be accessed automatically after receiving the encrypted link or in response to the document viewer window finishing initializing, such that displaying the one or more documents selected for display is not delayed. Alternatively, the encrypted link may be stored and the user may be prompted to confirm access to the one or more documents selected for display by submitting a request to access the document with the encrypted link. In this alternative, a content consuming user may submit multiple requests prior to accessing the one or more documents related to those requests such that all documents across multiple requests may be viewed at the same time. A request to access the document using the encrypted link may be confirmed to be submitted on behalf of the content consuming user as a particular user by accessing information stored for a particular application session accessed by the particular user via a secure protocol.

In one embodiment, the content management system calls a microservice to fulfill requests for access to content. The microservice performs a set of operations given a known input to produce a known output. The microservice may be called by a call command such as an API call that includes information needed for the microservice's functions such as the content ID of the one or more documents selected for viewing. Accessing the encrypted link calls the microservice for fulfilling the request by serving the content data for displaying the one or more documents selected for display in a format usable by the content access application. The microservice is used to access content for documents of a request, convert the content for documents of the request into a particular document format, and generate a method of transmitting the data of the documents to the content access application. When an encrypted link is accessed, the content management system may automatically call a microservice for performing the above actions.

In one embodiment, an identity management system of an application may be accessed to determine a user identifier of a link owner when an encrypted link is generated, and the user identifier of the link owner may be validated as a user identifier that has access to the document when the encrypted link is created. As long as the encrypted link has not expired, use of the encrypted link by a user may allow the user to access the document once the user is confirmed to be the link owner. A link may be expired, for example, if privileges to access the document have changed or if an expiry time stored in association with the encrypted link has been reached (e.g., valid for 1, 2, 3, 4, 5, 6, or 7 hours/days/weeks/months from creation). As the link owner has already been validated as a user with access to the document during link creation, a microservice or other service that fulfills a document request using the created link may check that the user requesting the document matches the link owner without re-checking the document settings as stored and managed in the database.

In one embodiment, once a microservice has been provided with an encrypted link, the microservice may decrypt the encrypted link to determine the document identifier, link owner user identifier, set of user credentials, or any other encoded information in the encrypted link. The document identifier decrypted from the link is used by the microservice to generate a request to the database to supply the content for the one or more documents selected for viewing. The microservice may also perform an authentication of the request by comparing the link owner user identifier or set of user credentials decrypted from the encrypted link to a particular user identifier or set of user credentials supplied with the call to the microservice by the content access application's current session.

The content access application may alter the encrypted link by appending to the encrypted link a limitation to the view of the document. The limitation may be a partial selection of data of the document such as page numbers of the document that are desired. When accessing this altered encrypted link, the microservice may still be called, however, the microservice may only retrieve content that meets the limitation appended to the encrypted link such as by requesting from the content management system only those pages of the document that fit a page numbering limitation. The microservice may, after receiving the limited content, only transform the limited content into a PDF format for display.

The database receives, from the microservice, the one or more requests for content, including the content IDs for each of the one or more documents selected for viewing. The content IDs for the one or more documents selected for viewing are used by the database to find the content for each of the one or more documents selected for viewing. The database finds the content for the one or more documents selected for viewing by comparing the content IDs for each of the one or more documents selected for viewing against the documents stored within the database. For example, the database may store a table of stored documents that associates each content ID with a reference used to identify the stored content for the document associated with the content ID. After identifying the content for the one or more documents selected for viewing, the database may optionally check the content to determine further information about the content such as a total content size to be sent to the content access application.

A document may be stored within the database in association with structured data about the document. The structured data may be, for example, metadata about the document or classifying data stored in association with the document in an original document storage prior to upload to the database. The database may return, for a request to access content for a document with associated structured data, the structured data in addition to the content. The microservice, upon receiving structured data in association with content for a document, may determine a means of formatting the structured data such that the structured data may be included in a PDF document format. For example, the microservice may append to the generated PDF formatted version of the content a PDF formatted version of the structured data. As another example, the structured data may be used to generate a new pdf that corresponds just to the structured data, with or without other document contents. The structured data may then be displayed in or as part of the PDF document of the contents displayed in the document viewer.

Database-side access control to documents may be enforced by the database within fulfilling the request to access to the content of a document. The request may be sent to the database along with security information about the request such as user credentials or a limitation to the content of the document to return. In the case of transmitting user credentials, the database may compare the user credentials to access controls associated with the document to determine a permissible content data of the document to return. In another embodiment, the content data of the document may be encrypted using one or more credentials for each piece of data of the document. The user credentials may be used to decrypt the portions of the content data of the document that meet the access level of the user credentials and leaving portions of the content data of the document where the user credentials do not meet the access level of the content data encrypted and inaccessible by the microservice. In the case that the request is transmitted with limitations to the content of the document to return, the database may retrieve all content data for the document that fit within the limitation specified. For example, a request may be transmitted with a limitation to only return the first ten pages of the document, in which case the database will only return the content data for the first ten pages of the document. In this way, the content data received by the microservice to be converted into a PDF format and displayed may only include the limited pages or content permitted by the database and further content data of the document is not exposed to the document viewer.

### Serving Document Contents

The microservice, upon receiving the data of the content, converts the content into a PDF document type. The microservice may convert documents of many different types using a software development kit (SDK) for converting unstructured data into a PDF document format such as the Oracle Outside In Technologies Library PDF Export SDK. The SDK may utilize a plurality of input filters which each read a specified document format and use a standard set of function calls to send the data to a server for interpretation tasks. The data obtained through the input filters may be cached by a chunker to designate a set amount of data for handling at a time by an export module. The export module handles export of data from the chunker via a set of export filters that determine formatting based on the data in the cache. After the export module has generated an export to an output document for each of the chunks of cached data in the chunker, the output document is finalized and sent back to the microservice as a complete PDF document. The microservice may pass to the SDK, along with the input document content, a set of standard settings for PDF output preferences. The set of standard settings may be defined by a user by setting display settings for PDFs within the document viewer.

The content is converted into a PDF document type so that the content will be of a consistent document type when serving the content to the content access application. Using a consistent document type such as the PDF document type allows for optimizations to be built that may rely on the documents displayed in the document viewer to be of a certain document type. The PDF document type is widely supported and can be used within a web browser such that the content access application may be a lightweight application such as a web application. The PDF document type is also usable across many devices, especially small devices such as handhelds, tablets, or smartphones. Converting content into a PDF allows for a variety of original document types to be viewed as many document types are convertible to a PDF format: text documents such as Microsoft word documents or plain text documents, tabular data files such as Microsoft Excel files, XML or CSV files, email or MIME files, image file formats such as PNG, JPEG, or TIF, or any contents of a compressed folder such as a ZIP, RAR, or 7Z file. Converting into a PDF document format may also remove unwanted, hidden data that may exist within a document, leading to greater security for the consuming user in viewing the document. The PDF document format is also useful in that the PDF document format is editable allowing the document viewer to include document editing tools for a consuming user. In order to improve performance of the translation to PDF, the microservice may cache fonts or PDF data structures used for prior documents translated into PDF that may be used for further requests from the same user. For example, a document may contain a particular font which the microservice needs to download for converting the document to a PDF format. The microservice may cache the downloaded font such that for a second document accessed that may contain the downloaded font, the processing of the second document is not delayed by downloading the font for converting the second document to a PDF format.

The microservice, after converting the content for the one or more documents selected for viewing into a PDF format, transmits the PDF formatted content to the content access application. The microservice may serve the PDF formatted content for the content access application to download. Alternatively, the microservice may generate a data stream provided to the content access application. The data stream may be a byte stream, where data is transmitted one byte at a time as a series of small packages of data. One example stream data protocol is that offered by Redis®. Other stream data sources are also available for distributing data to one or more recipients in a stream that allows the data to be asynchronously consumed by the consumer. The data is asynchronously consumed because the stream data source awaits acknowledgement from the consumer about which data has been consumed, and the stream data source expires only that data which has been consumed. The stream data source awaits acknowledgement for the rest of the data. Loading the data of the PDF formatted content as a data stream allows, if the data stream is sequential for the order of viewing data within the document, the document viewer to begin to display the content without yet having the data of the entire document if a delimiter is added within the data stream to indicate a separation within the stream of a current loaded portion of the content. In an alternative embodiment, content for a document may be divided into multiple separate streams which may be compiled by the content access application either to increase the rate of data transfer or to load portions of a document prior to receiving the entire data stream of a document. After receiving the content or a partial content, in a PDF format, the content access application displays the content of the one or more documents selected for viewing within the document viewer.

In another embodiment, the transformation of a plurality of documents or a plurality of sub-document divisions of a single document may be performed as a multi-threaded parallel transformation. In the case that a plurality of documents is selected for viewing, each of the documents of the plurality of documents may be transformed via parallel processes such that the amount of time to access each document is reduced. A document may be divided into a plurality of sub-document divisions which may each be transformed by parallel processes.

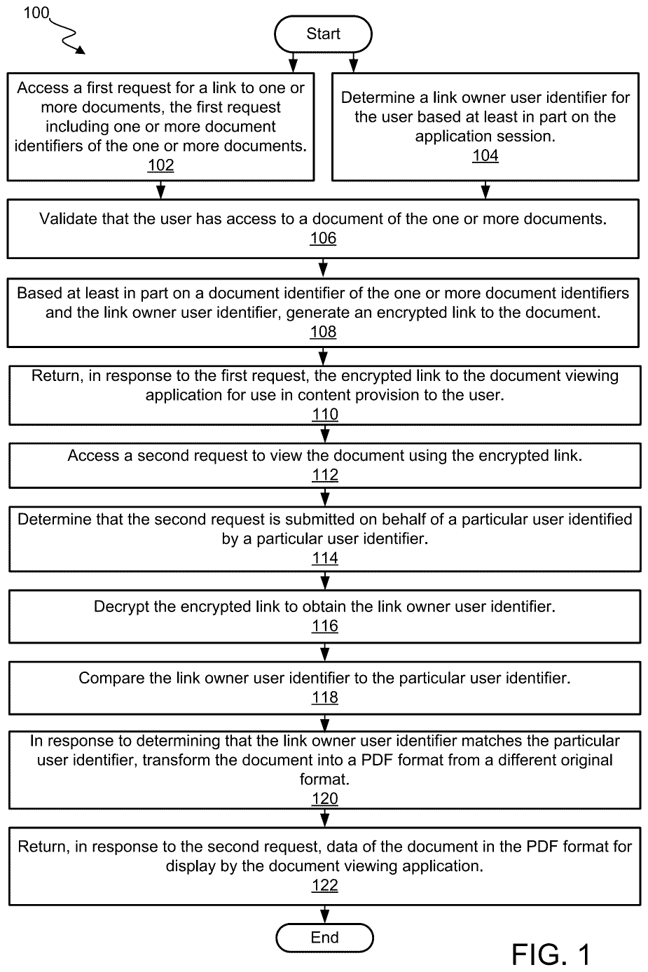

FIG. 1 depicts a flow chart 100 of an example process for providing access to securely view documents. First, at block 102, a first request is accessed where the request is for a link to access one or more documents. The request contains one or more document identifiers. The first request is associated with an application session for content provision to a user of a document viewing application. At block 104, a link owner user identifier for the user is identified based at least in part on the application session. The link owner user identifier may be a set of user credentials used by the document viewing application. At block 106, the system validates that the user has access to a document of the one or more documents. The validations may be performed by comparing the link owner user identifier to a set of user access controls. At block 108, based at least in part on a document identifier of the one or more document identifiers and the link owner user identifier, the system generates an encrypted link to the document. At block 110, the encrypted link is returned to the document viewing application, in response to the first request and for use in content provision to the user. At block 112, the system accesses a second request to view the document using the encrypted link. At block 114, the system determines that the second request is submitted on behalf of a particular user identified by a particular user identifier. At block 116, the encrypted link is decrypted to obtain the link owner user identifier. At block 118, the link owner user identifier is compared to the particular user identifier. In response to determining that the link owner user identifier matches the particular user identifier, at block 120, the system transforms the document into a PDF format from a different original format. At block 122, data of the document in the PDF format is returned in response to the second request for display by the document viewing application.

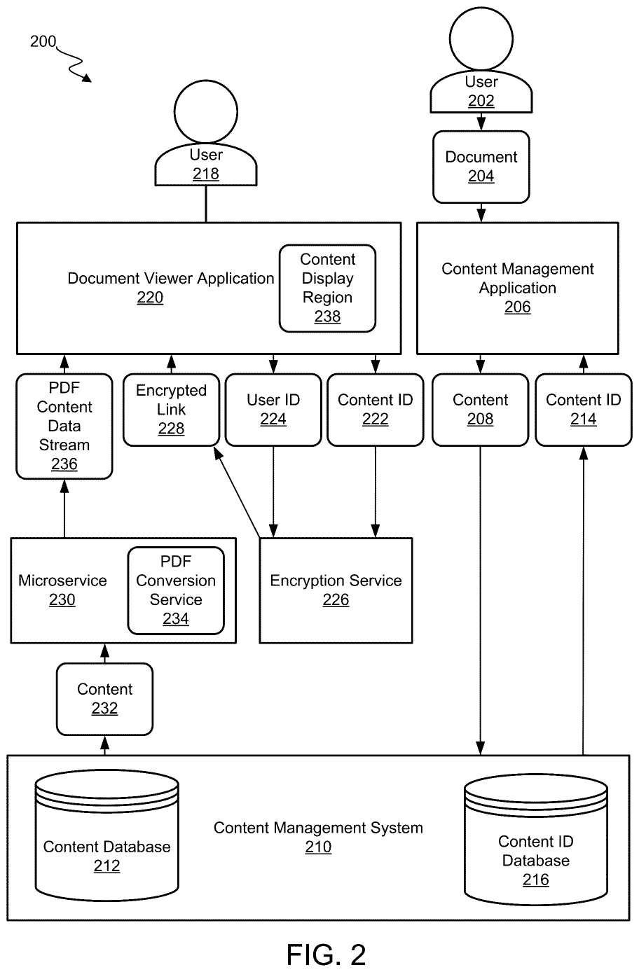

FIG. 2 depicts a distributed system 200 for providing access to securely view documents. A content management user 202 uploads a document 204 to a content management application 206. The content management application may perform tasks to facilitate making the document 204 available to access by other users. The content management application 206 uploads the document content 208 to a content management system 210 which stores the content 208 in a content database 212. The content management system 210 generates a content ID 214 which is stored in a content ID database 216 which associates the content ID 214 with the corresponding content 208 within the content database 212. The content management system 210 returns to the content management application 206 the content ID 214. The content management application 206 may store the content ID 214. A content consuming user 218 accesses a document viewer application 220 to request to view a document such as the document 204. The document viewer application 220 may be the same application as the content management application 206 or may be updated by the content management system 210 to recognize content IDs stored in the content ID database 216. The content consuming user 218 submits a request for a document which the document viewer application 220 associates with a content ID 222. The document viewer application 220 also identifies a user ID 224 for the content consuming user 218. The document viewer application 220 submits the content ID 222 and the user ID 224 to an encryption service 226. The encryption service 226 generates, at least based on the content ID 222 and the user ID 224, an encrypted link 228 and returns the encrypted link 228 to the document viewer application 220. The document viewer application 220 accesses the encrypted link, which calls a microservice 230 to fulfil the request for the document. The microservice receives, from the content database 212, content 232 representing the document requested. The microservice 230 converts the content 232 to a PDF format via a PDF conversion service 234. The microservice 230 then transmits to the document viewer application 220, a PDF content data stream 236 such that the document viewer application 220 may load the document in a content display region 238 for displaying to the content consuming user 218.

### Actions in Viewing Documents

When viewing a document in the document viewer, the consuming user may interact with the currently displayed document by navigating between documents or selecting one or more actions relevant to the document. In the case that more than one document is selected for viewing, the document viewer may contain navigation buttons for selecting to view a next or previous document. The current document displayed may change to another document of the documents selected for viewing based on a user selection of the navigation buttons. The document viewer may also contain a document selection option for selecting from a list of the selected documents for viewing that a user may select from to determine the current document displayed in the document viewer.

In the case that documents are related, such as in a hierarchical structure of documents, selecting one document of the hierarchy may automatically select one or more other documents of the hierarchy as selected documents for viewing. In this case the document viewer may display the documents within their hierarchy and a user may navigate the documents from the display of the hierarchy. For example, a document selected for viewing may be a record of an email with attachments. In selecting the email for viewing, the attachments are automatically selected as well for viewing. When viewing the email within the document viewer, the attachments may be listed as child documents to the email document in a document hierarchy display and may be selected for viewing as well.

Based on a document type or based on information or settings stored in association with a document, one or more actions may be identified as available actions to perform with respect to a document. A content management user may define one or more actions to be allowed for a document at the time of uploading the document to the database. Alternatively, a set of actions may be defined for a document type such that a document may inherit the possible actions of the document type when assigned or detected to be of that document type. When displaying a document in the document viewer where one or more possible actions have been identified, the document viewer may also display the one or more possible actions as options for the content consuming user to trigger.

In yet another alternative, the one or more actions may be identified as available actions to perform with respect to the document at runtime or the time of detecting access to the encrypted link. The microservice may determine the one or more actions based on metadata of the document received from the database prior to converting the document to PDF format. The metadata of the document may include, for example, a document type, an ownership, an access level, a security feature, a file type, an author, a subject, one or more keywords, a language, a page count, a file size, or any custom or organization-specific metadata. The metadata may also include a state of a base entity that owns the document. For example, a document may be owned by an application page which causes the microservice to display “approve” or “reject” action options. In another example, the same document may be owned by a candidate profile page which causes the microservice to display “add as prospect” or “add to event” action options. In yet another example, the same document may be owned by a prospective candidate page which causes the microservice to display “convert to application” or “remove application” action options. The microservice may return to the user interface the determined one or more actions to display with the PDF format of the document.

Examples of possible optional actions for a document include: approving a document, copying a document, sharing a document, automatically filling in a document, editing a document, or downloading a document. Actions selected for performance by a content consuming user may be registered as an action event that may be passed to another application as a request to perform the requested action for the document. Alternatively, the actions selected for performance may be stored as javascript automations that are called when a content consuming user selects the action and display a number of editable parameters for the content consuming user to interact with before approving and running the javascript program. In one example, an action may be defined for printing the current set of documents. The print action may perform a call on the microservice to reacquire the content for each of the current set of documents and combine the content into a single PDF when performing the transformation into a PDF format. The microservice may also be instructed to include metadata about the organization of the documents such as a document hierarchy as structured data, which may then be formatted by the microservice into a format that may be transformed into a PDF document to append to the beginning or end of the compiled PDF document for the set of documents.

One action for a document may be to generate and display a summary for a document. In this case, a document may be requested and displayed within the document viewer and an action may be triggered, either by action of the user or by an automatic triggering of the action, to generate and display a summary of the document. The document viewer may call an optical character recognition (OCR) service to recognize text within the document if the document does not currently encode all included text in a text formatting. Once all text within the document is within a text formatting and selectable, the document viewer may select the total text of the document to use as an input to a large language model as part of a prompt to generate a summary of the document. The prompt may include one or more additional instructions directing the large language model to generate a summary of the document based on the included text selected from the document. The document viewer receives a document summary from the large language model, which the document viewer may display in addition to the document.

Actions may be performed together as sets of actions based on whether an action is a default action or an optional action. Default actions may be performed as a set of actions at the time of transforming the document into a PDF format such that performance of the set of default actions may be completed prior to displaying the document in the document viewer. Optional actions may be performed as selected by the user for performance after the document viewer displays the document. The optional actions may be performed individually at the time of the user selecting the actions for performance for the document or may be recorded and performed together as a set of actions at a particular time such as after the user has closed the document within the document viewer.

### Computer System Architecture

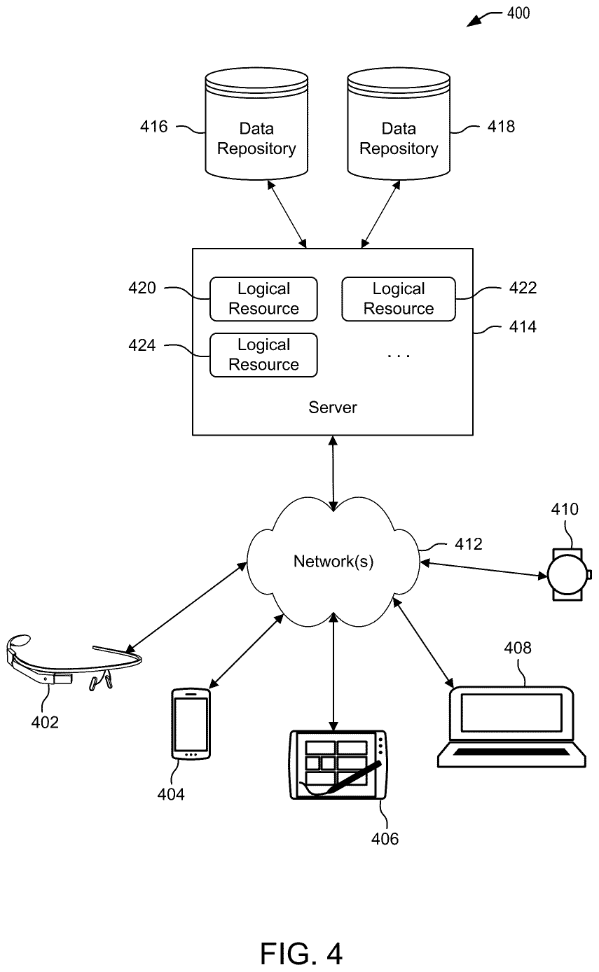

FIG. 4 depicts a simplified diagram of a distributed system 400 for implementing an embodiment. In the illustrated embodiment, distributed system 400 includes one or more client computing devices 402, 404, 406, 408, and/or 410 coupled to a server 414 via one or more communication networks 412. Clients computing devices 402, 404, 406, 408, and/or 410 may be configured to execute one or more applications.

In various aspects, server 414 may be adapted to run one or more services or software applications that enable techniques for providing access to securely view documents.

In certain aspects, server 414 may also provide other services or software applications that can include non-virtual and virtual environments. In some aspects, these services may be offered as web-based or cloud services, such as under a Software as a Service (SaaS) model to the users of client computing devices 402, 404, 406, 408, and/or 410. Users operating client computing devices 402, 404, 406, 408, and/or 410 may in turn utilize one or more client applications to interact with server 414 to utilize the services provided by these components.

In the configuration depicted in FIG. 4, server 414 may include one or more components 420, 422 and 424 that implement the functions performed by server 414. These components may include software components that may be executed by one or more processors, hardware components, or combinations thereof. It should be appreciated that various different system configurations are possible, which may be different from distributed system 400. The embodiment shown in FIG. 4 is thus one example of a distributed system for implementing an embodiment system and is not intended to be limiting.

Users may use client computing devices 402, 404, 406, 408, and/or 410 for techniques for providing access to securely view documents in accordance with the teachings of this disclosure. A client device may provide an interface that enables a user of the client device to interact with the client device. The client device may also output information to the user via this interface. Although FIG. 4 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 412 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 412 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 414 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 414 can include one or more virtual machines running virtual operating systems, or other computing architectures involving virtualization such as one or more flexible pools of logical storage devices that can be virtualized to maintain virtual storage devices for the server. In various aspects, server 414 may be adapted to run one or more services or software applications that provide the functionality described in the foregoing disclosure.

The computing systems in server 414 may run one or more operating systems including any of those discussed above, as well as any commercially available server operating system. Server 414 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 414 may include one or more applications to analyze and consolidate data feeds and/or event updates received from users of client computing devices 402, 404, 406, 408, and/or 410. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 414 may also include one or more applications to display the data feeds and/or real-time events via one or more display devices of client computing devices 402, 404, 406, 408, and/or 410.

Distributed system 400 may also include one or more data repositories 416, 418. These data repositories may be used to store data and other information in certain aspects. For example, one or more of the data repositories 416, 418 may be used to store information for techniques for providing access to securely view documents. Data repositories 416, 418 may reside in a variety of locations. For example, a data repository used by server 414 may be local to server 414 or may be remote from server 414 and in communication with server 414 via a network-based or dedicated connection. Data repositories 416, 418 may be of different types. In certain aspects, a data repository used by server 414 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 416, 418 may also be used by applications to store application data. The data repositories used by applications may be of different types such as, for example, a key-value store repository, an object store repository, or a general storage repository supported by a file system.

In one embodiment, server 414 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

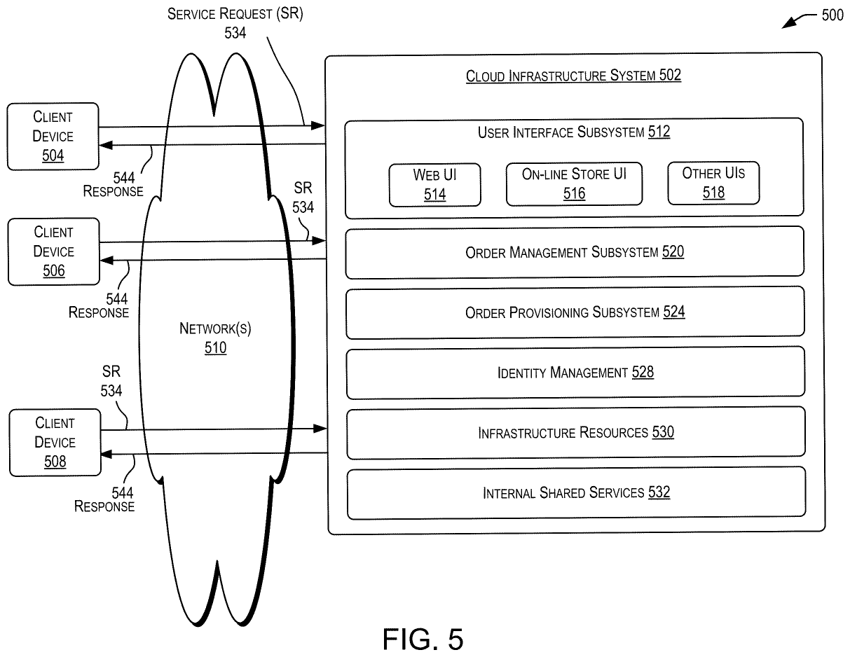

FIG. 5 is a simplified block diagram of a cloud-based system environment in which providing access to securely view documents, in accordance with certain aspects may be performed. In the embodiment depicted in FIG. 5, cloud infrastructure system 502 may provide one or more cloud services that may be requested by users using one or more client computing devices 504, 506, and 508. Cloud infrastructure system 502 may comprise one or more computers and/or servers that may include those described above for server 414. The computers in cloud infrastructure system 502 may be organized as general purpose computers, specialized server computers, server farms, server clusters, or any other appropriate arrangement and/or combination.

Network(s) 510 may facilitate communication and exchange of data between clients 504, 506, and 508 and cloud infrastructure system 502. Network(s) 510 may include one or more networks. The networks may be of the same or different types. Network(s) 510 may support one or more communication protocols, including wired and/or wireless protocols, for facilitating the communications.

The embodiment depicted in FIG. 5 is only one example of a cloud infrastructure system and is not intended to be limiting. It should be appreciated that, in some other aspects, cloud infrastructure system 502 may have more or fewer components than those depicted in FIG. 5, may combine two or more components, or may have a different configuration or arrangement of components. For example, although FIG. 5 depicts three client computing devices, any number of client computing devices may be supported in alternative aspects.

The term cloud service is generally used to refer to a service that is made available to users on demand and via a communication network such as the Internet by systems (e.g., cloud infrastructure system 502) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 510 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 502 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 502 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 502. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 502. Cloud infrastructure system 502 then performs processing to provide the services requested in the tenant's subscription order. Cloud infrastructure system 502 may be configured to provide one or even multiple cloud services.

Cloud infrastructure system 502 may provide the cloud services via different deployment models. In a public cloud model, cloud infrastructure system 502 may be owned by a third party cloud services provider and the cloud services are offered to any general public tenant, where the tenant can be an individual or an enterprise. In certain other aspects, under a private cloud model, cloud infrastructure system 502 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 502 and the services provided may be shared by several organizations in a related community. Various other models such as hybrids of the above mentioned models may also be used.

Client computing devices 504, 506, and 508 may be of different types (such as devices 402, 404, 406, and 408 depicted in FIG. 4) and may be capable of operating one or more client applications. A user may use a client device to interact with cloud infrastructure system 502, such as to request a service provided by cloud infrastructure system 502.

In some aspects, the processing performed by cloud infrastructure system 502 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 502 for determining the intent of an utterance. The data used for this analysis may include structured data (e.g., data stored in a database or structured according to a structured model) and/or unstructured data (e.g., data blobs (binary large objects)).

As depicted in the embodiment in FIG. 5, cloud infrastructure system 502 may include infrastructure resources 530 that are utilized for facilitating the provision of various cloud services offered by cloud infrastructure system 502. Infrastructure resources 530 may include, for example, processing resources, storage or memory resources, networking resources, and the like.

In certain aspects, to facilitate efficient provisioning of these resources for supporting the various cloud services provided by cloud infrastructure system 502 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 502 may itself internally use services 532 that are shared by different components of cloud infrastructure system 502 and which facilitate the provisioning of services by cloud infrastructure system 502. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 502 may comprise multiple subsystems. These subsystems may be implemented in software, or hardware, or combinations thereof. As depicted in FIG. 5, the subsystems may include a user interface subsystem 512 that enables users of cloud infrastructure system 502 to interact with cloud infrastructure system 502. User interface subsystem 512 may include various different interfaces such as a web interface 514, an online store interface 516 where cloud services provided by cloud infrastructure system 502 are advertised and are purchasable by a consumer, and other interfaces 518. For example, a tenant may, using a client device, request (service request 534) one or more services provided by cloud infrastructure system 502 using one or more of interfaces 514, 516, and 518. For example, a tenant may access the online store, browse cloud services offered by cloud infrastructure system 502, and place a subscription order for one or more services offered by cloud infrastructure system 502 that the tenant wishes to subscribe to. The service request may include information identifying the tenant and one or more services that the tenant desires to subscribe to. For example, a tenant may place a subscription order for a chatbot related service offered by cloud infrastructure system 502. As part of the order, the client may provide information identifying the input (e.g. utterances).

In certain aspects, such as the embodiment depicted in FIG. 5, cloud infrastructure system 502 may comprise a service management subsystem (OMS) 520 that is configured to process the new order. As part of this processing, OMS 520 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 520 may then invoke the service provisioning subsystem (OPS) 524 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 524 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 502 may send a response or notification 544 to the requesting tenant to indicate when the requested service is now ready for use. In some instances, information (e.g., a link) may be sent to the tenant that enables the tenant to start using and availing the benefits of the requested services.

Cloud infrastructure system 502 may provide services to multiple tenants. For each tenant, cloud infrastructure system 502 is responsible for managing information related to one or more subscription orders received from the tenant, maintaining tenant data related to the orders, and providing the requested services to the tenant or clients of the tenant. Cloud infrastructure system 502 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 502 may provide services to multiple tenants in parallel. Cloud infrastructure system 502 may store information for these tenants, including possibly proprietary information. In certain aspects, cloud infrastructure system 502 comprises an identity management subsystem (IMS) 528 that is configured to manage tenant's information and provide the separation of the managed information such that information related to one tenant is not accessible by another tenant. IMS 528 may be configured to provide various security-related services such as identity services, such as information access management, authentication and authorization services, services for managing tenant identities and roles and related capabilities, and the like.

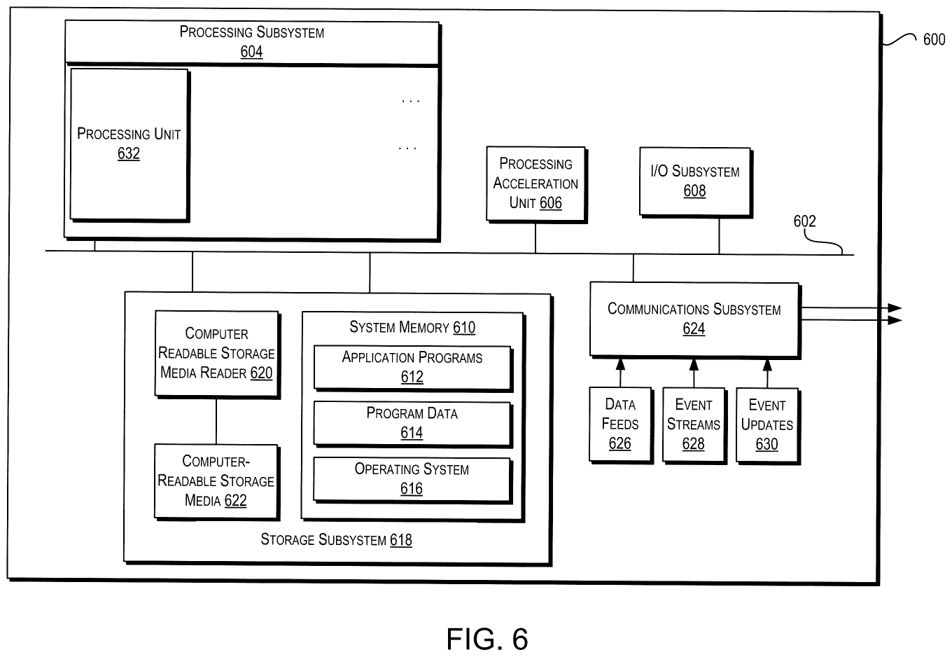

FIG. 6 illustrates an exemplary computer system 600 that may be used to implement certain aspects. As shown in FIG. 6, computer system 600 includes various subsystems including a processing subsystem 604 that communicates with a number of other subsystems via a bus subsystem 602. These other subsystems may include a processing acceleration unit 606, an I/O subsystem 608, a storage subsystem 618, and a communications subsystem 624. Storage subsystem 618 may include non-transitory and/or transitory computer-readable storage media including storage media 622 and a system memory 610.

Bus subsystem 602 provides a mechanism for letting the various components and subsystems of computer system 600 communicate with each other as intended. Although bus subsystem 602 is shown schematically as a single bus, alternative aspects of the bus subsystem may utilize multiple buses. Bus subsystem 602 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 604 controls the operation of computer system 600 and may comprise one or more processors, application specific integrated circuits (ASICs), or field programmable gate arrays (FPGAs). The processors may be single core or multicore processors. The processing resources of computer system 600 can be organized into one or more processing units 632, 634, etc. A processing unit may include one or more processors, one or more cores from the same or different processors, a combination of cores and processors, or other combinations of cores and processors. In some aspects, processing subsystem 604 can include one or more special purpose co-processors such as graphics processors, digital signal processors (DSPs), or the like. In some aspects, some or all of the processing units of processing subsystem 604 can be implemented using customized circuits, such as application specific integrated circuits (ASICs), or field programmable gate arrays (FPGAs).

In some aspects, the processing units in processing subsystem 604 can execute instructions stored in system memory 610 or on computer readable storage media 622. In various aspects, the processing units can execute a variety of programs or code instructions and can maintain multiple concurrently executing programs or processes. At any given time, some or all of the program code to be executed can be resident in system memory 610 and/or on computer-readable storage media 622 including potentially on one or more storage devices. Through suitable programming, processing subsystem 604 can provide various functionalities described above. In instances where computer system 600 is executing one or more virtual machines, one or more processing units may be allocated to each virtual machine.

In certain aspects, a processing acceleration unit 606 may optionally be provided for performing customized processing or for off-loading some of the processing performed by processing subsystem 604 so as to accelerate the overall processing performed by computer system 600.

I/O subsystem 608 may include devices and mechanisms for inputting information to computer system 600 and/or for outputting information from or via computer system 600. In general, use of the term input device is intended to include all possible types of devices and mechanisms for inputting information to computer system 600. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 600 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 618 provides a repository or data store for storing information and data that is used by computer system 600. Storage subsystem 618 provides a tangible non-transitory computer-readable storage medium for storing the basic programming and data constructs that provide the functionality of some aspects. Storage subsystem 618 may store software (e.g., programs, code modules, instructions) that when executed by processing subsystem 604 provides the functionality described above. The software may be executed by one or more processing units of processing subsystem 604. Storage subsystem 618 may also provide a repository for storing data used in accordance with the teachings of this disclosure.

Storage subsystem 618 may include one or more non-transitory memory devices, including volatile and non-volatile memory devices. As shown in FIG. 6, storage subsystem 618 includes a system memory 610 and a computer-readable storage media 622. System memory 610 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 600, such as during start-up, may typically be stored in the ROM. The RAM typically contains data and/or program modules that are presently being operated and executed by processing subsystem 604. In some implementations, system memory 610 may include multiple different types of memory, such as static random access memory (SRAM), dynamic random access memory (DRAM), and the like.

By way of example, and not limitation, as depicted in FIG. 6, system memory 610 may load application programs 612 that are being executed, which may include various applications such as Web browsers, mid-tier applications, relational database management systems (RDBMS), etc., program data 614, and an operating system 616. By way of example, operating system 616 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 622 may store programming and data constructs that provide the functionality of some aspects. Computer-readable media 622 may provide storage of computer-readable instructions, data structures, program modules, and other data for computer system 600. Software (programs, code modules, instructions) that, when executed by processing subsystem 604 provides the functionality described above, may be stored in storage subsystem 618. By way of example, computer-readable storage media 622 may include non-volatile memory such as a hard disk drive, a magnetic disk drive, an optical disk drive such as a CD ROM, digital video disc (DVD), a Blu-Ray® disk, or other optical media. Computer-readable storage media 622 may include, but is not limited to, Zip® drives, flash memory cards, universal serial bus (USB) flash drives, secure digital (SD) cards, DVD disks, digital video tape, and the like. Computer-readable storage media 622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 618 may also include a computer-readable storage media reader 620 that can further be connected to computer-readable storage media 622. Reader 620 may receive and be configured to read data from a memory device such as a disk, a flash drive, etc.

In certain aspects, computer system 600 may support virtualization technologies, including but not limited to virtualization of processing and memory resources. For example, computer system 600 may provide support for executing one or more virtual machines. In certain aspects, computer system 600 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 600. Accordingly, multiple operating systems may potentially be run concurrently by computer system 600.

Communications subsystem 624 provides an interface to other computer systems and networks. Communications subsystem 624 serves as an interface for receiving data from and transmitting data to other systems from computer system 600. For example, communications subsystem 624 may enable computer system 600 to establish a communication channel to one or more client devices via the Internet for receiving and sending information from and to the client devices. For example, the communications subsystem may be used to transmit a response to a user regarding the inquiry for a chatbot.

Communications subsystem 624 may support both wired and/or wireless communication protocols. For example, in certain aspects, communications subsystem 624 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 624 can provide wired network connectivity (e.g., Ethernet) in addition to or instead of a wireless interface.

Communications subsystem 624 can receive and transmit data in various forms. For example, in some aspects, in addition to other forms, communications subsystem 624 may receive input communications in the form of structured and/or unstructured data feeds 626, event streams 628, event updates 630, and the like. For example, communications subsystem 624 may be configured to receive (or send) data feeds 626 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 624 may be configured to receive data in the form of continuous data streams, which may include event streams 628 of real-time events and/or event updates 630, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 624 may also be configured to communicate data from computer system 600 to other computer systems or networks. The data may be communicated in various different forms such as structured and/or unstructured data feeds 626, event streams 628, event updates 630, and the like to one or more databases that may be in communication with one or more streaming data source computers coupled to computer system 600.

Computer system 600 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 600 depicted in FIG. 6 is intended only as a specific example. Many other configurations having more or fewer components than the system depicted in FIG. 6 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
accessing a first request for a link to one or more documents, wherein the first request comprises one or more document identifiers of the one or more documents, and wherein the first request is associated with an application session for content provision to a user of a document viewing application;
determining a link owner user identifier for the user based at least in part on the application session;
validating that the user has access to a document of the one or more documents;
after validating that the user has access to the document and based at least in part on a document identifier of the one or more document identifiers and the link owner user identifier, generating an encrypted link to the document;
returning, in response to the first request, the encrypted link to the document viewing application for use in content provision to the user ;
accessing a second request to view the document using the encrypted link;
determining that the second request is submitted on behalf of a particular user identified by a particular user identifier;
decrypting the encrypted link to obtain the link owner user identifier;
comparing the link owner user identifier to the particular user identifier;
in response to determining that the link owner user identifier matches the particular user identifier, transforming data of the document into a PDF format from a different original format;
returning, in response to the second request, the data of the document in the PDF format for display by the document viewing application.

2. The computer-implemented method of claim 1, wherein the determining that the second request is submitted on behalf of the particular user identified by the particular user identifier comprises accessing information stored for a particular application session from which the second request originated; wherein the accessing the particular user identifier is performed via a secure protocol.

3. The computer-implemented method of claim 1, wherein the second request further comprises a request to view a second document using a second encrypted link, and wherein the computer-implemented method further comprises:
decrypting the second encrypted link to obtain the link owner user identifier;
in response to determining that the link owner user identifier matches the particular user identifier, transforming data of the second document into a PDF format from a different original format;
returning, in response to the second request, the data of the second document in the PDF format for display by the document viewing application.

4. The computer-implemented method of claim 1, wherein the first request
from the user is one of a plurality of requests for links to documents; and wherein
the computer-implemented method further comprises:
accessing a third request from the user for a second link to a second document, wherein the third request comprises a second document identifier;
after validating that the user has access to the second document and based at least in part on the second document identifier and the link owner user identifier, generating a second encrypted link to the second document.

5. The computer-implemented method of claim 1, wherein the first request
from the user is one of a plurality of requests for links to documents; and wherein
the computer-implemented method further comprises:
accessing a third request for a second link to a second document, wherein the third request comprises a second document identifier;
after validating that a corresponding user has access to the second document and based at least in part on the second document identifier and a corresponding link owner user identifier, generating a second encrypted link to the second document;
accessing a third request to view the second document using the second encrypted link;
determining that the third request is submitted on behalf of a second particular user identified by a second particular user identifier;
decrypting the second encrypted link to obtain the corresponding link owner user identifier;
comparing the corresponding link owner user identifier to the second particular user identifier;
in response to determining that the corresponding link owner user identifier matches the particular user identifier, transforming data of the second document into a PDF format from a different original format;
returning, in response to the third request, the data of the second document in the PDF format for display by the document viewing application;
wherein the transforming the data of the second document and the transforming the data of the document are performed in parallel.

6. The computer-implemented method of claim 1, wherein the user and the particular user are a same user of the document viewing application.

7. The computer-implemented method of claim 1, wherein the returning, in response to the second request, the data of the document in the PDF format for display by the document viewing application comprises transmitting a byte stream of the data of the document in the PDF format.

8. The computer-implemented method of claim 1, wherein the document is
displayed with an option to trigger a particular action, and wherein the computer-implemented method further comprises:
determining a type of action to support based at least in part on metadata about the document, wherein the particular action is of the determined type of action; and
detecting a user-initiated trigger of the particular action on the document, wherein different documents are displayed with options to trigger different actions;
in response to the user-initiated trigger, causing performance of the particular action on the document.

9. The computer-implemented method of claim 1, wherein the second request comprises a request to view one or more items of structured information associated with the document and wherein the computer-implemented method further comprises:
determining a layout for displaying the one or more items of structured information within a PDF format;
wherein transforming the data of the document into the PDF format comprises adding the one or more items of structured information in the determined layout to the data of the document in the PDF format.

10. The computer-implemented method of claim 1, wherein the transforming the data of the document into the PDF format is performed in a plurality of sub-steps with each sub-step comprising transforming a portion of the document into the PDF format,
wherein the returning, in response to the second request, the data of the document in the PDF format comprises returning a first portion of data of the document in the PDF format, and
wherein the computer-implemented method further comprises:
accessing a third request to access a second portion of the document;
transforming data of a second portion of the document into the PDF format; and
returning, in response to the third request, the data of the second portion of the document in the PDF format for display by the document viewing application.

11. The computer-implemented method of claim 1, wherein the accessing a second request to view the document using the encrypted link comprises accessing an appended limitation to the view of the document, and wherein the transforming the data of the document into the PDF format comprises transforming data corresponding to the limited view of the document without transforming data that does not correspond to the limited view of the document.

12. A computer-program product comprising one or more non-transitory machine-readable storage media, including stored instructions configured to cause a computing system to perform a set of actions including:
accessing a first request for a link to one or more documents, wherein the first request comprises one or more document identifiers of the one or more documents, and wherein the first request is associated with an application session for content provision to a user of a document viewing application;
determining a link owner user identifier for the user based at least in part on the application session;
validating that the user has access to a document of the one or more documents;
after validating that the user has access to the document and based at least in part on a document identifier of the one or more document identifiers and the link owner user identifier, generating an encrypted link to the document;
returning, in response to the first request, the encrypted link to the document viewing application for use in content provision to the user ;
accessing a second request to view the document using the encrypted link;
determining that the second request is submitted on behalf of a particular user identified by a particular user identifier;
decrypting the encrypted link to obtain the link owner user identifier;
comparing the link owner user identifier to the particular user identifier;
in response to determining that the link owner user identifier matches the particular user identifier, transforming data of the document into a PDF format from a different original format;
returning, in response to the second request, the data of the document in the PDF format for display by the document viewing application.

13. The computer-program product of claim 12, wherein the determining that the second request is submitted on behalf of the particular user identified by the particular user identifier comprises accessing information stored for a particular application session from which the second request originated; wherein the accessing the particular user identifier is performed via a secure protocol.

14. The computer-program product of claim 12, wherein the first request from the user is one of a plurality of requests for links to documents; and wherein the set of actions further includes:
accessing a third request from the user for a second link to a second document, wherein the third request comprises a second document identifier;
after validating that the user has access to the second document and based at least in part on the second document identifier and the link owner user identifier, generating a second encrypted link to the second document.

15. The computer-program product of claim 12, wherein the first request from the user is one of a plurality of requests for links to documents; and wherein the set of actions further includes:
accessing a third request for a second link to a second document, wherein the third request comprises a second document identifier;
after validating that a corresponding user has access to the second document and based at least in part on the second document identifier and a corresponding link owner user identifier, generating a second encrypted link to the second document;
accessing a third request to view the second document using the second encrypted link;
determining that the third request is submitted on behalf of a second particular user identified by a second particular user identifier;
decrypting the second encrypted link to obtain the corresponding link owner user identifier;
comparing the corresponding link owner user identifier to the second particular user identifier;
in response to determining that the corresponding link owner user identifier matches the particular user identifier, transforming data of the second document into a PDF format from a different original format;
returning, in response to the third request, the data of the second document in the PDF format for display by the document viewing application;
wherein the transforming the data of the second document and the transforming the data of the document are performed in parallel.

16. The computer-program product of claim 12, wherein the document is displayed with an option to trigger a particular action, and wherein the set of actions further includes:
determining a type of action to support based at least in part on metadata about the document, wherein the particular action is of the determined type of action; and
detecting a user-initiated trigger of the particular action on the document, wherein different documents are displayed with options to trigger different actions;
in response to the user-initiated trigger, causing performance of the particular action on the document.

17. A system comprising:
one or more processors;
one or more non-transitory computer-readable media storing instructions, which, when executed by the system, cause the system to perform a set of actions including:
accessing a first request for a link to one or more documents, wherein the first request comprises one or more document identifiers of the one or more documents, and wherein the first request is associated with an application session for content provision to a user of a document viewing application;
determining a link owner user identifier for the user based at least in part on the application session;
validating that the user has access to a document of the one or more documents;
after validating that the user has access to the document and based at least in part on a document identifier of the one or more document identifiers and the link owner user identifier, generating an encrypted link to the document;
returning, in response to the first request, the encrypted link to the document viewing application for use in content provision to the user ;
accessing a second request to view the document using the encrypted link;
determining that the second request is submitted on behalf of a particular user identified by a particular user identifier;
decrypting the encrypted link to obtain the link owner user identifier;
comparing the link owner user identifier to the particular user identifier;
in response to determining that the link owner user identifier matches the particular user identifier, transforming data of the document into a PDF format from a different original format;
returning, in response to the second request, the data of the document in the PDF format for display by the document viewing application.

18. The system of claim 17, wherein the determining that the second request is submitted on behalf of the particular user identified by the particular user identifier comprises accessing information stored for a particular application session from which the second request originated; wherein the accessing the particular user identifier is performed via a secure protocol.

19. The system of claim 17, wherein the first request from the user is one of a plurality of requests for links to documents; and wherein the set of actions further includes:
accessing a third request from the user for a second link to a second document, wherein the third request comprises a second document identifier;
after validating that the user has access to the second document and based at least in part on the second document identifier and the link owner user identifier, generating a second encrypted link to the second document.

20. The system of claim 17, wherein the first request from the user is one of a plurality of requests for links to documents; and wherein the set of actions further includes:
accessing a third request for a second link to a second document, wherein the third request comprises a second document identifier;
after validating that a corresponding user has access to the second document and based at least in part on the second document identifier and a corresponding link owner user identifier, generating a second encrypted link to the second document;
accessing a third request to view the second document using the second encrypted link;
determining that the third request is submitted on behalf of a second particular user identified by a second particular user identifier;
decrypting the second encrypted link to obtain the corresponding link owner user identifier;
comparing the corresponding link owner user identifier to the second particular user identifier;
in response to determining that the corresponding link owner user identifier matches the particular user identifier, transforming data of the second document into a PDF format from a different original format;
returning, in response to the third request, the data of the second document in the PDF format for display by the document viewing application;
wherein the transforming the data of the second document and the transforming the data of the document are performed in parallel.

21. The system of claim 17, wherein the document is displayed with an option to trigger a particular action, and wherein the set of actions further includes:
determining a type of action to support based at least in part on metadata about the document, wherein the particular action is of the determined type of action; and
detecting a user-initiated trigger of the particular action on the document, wherein different documents are displayed with options to trigger different actions;
in response to the user-initiated trigger, causing performance of the particular action on the document.
